(19) United States
(12) Patent Application Publication
(10) Pub. No.: US 2014/0279113 A1
(43) Pub. Date: Sep. 18, 2014

(54) System and Method to Reduce Misuse of a Financial Instrument at a Point-of-Sale Location

(71) Applicant: Harish Balasubramanian, Bangalore (IN)

(72) Inventor: Harish Balasubramanian, Bangalore (IN)

(21) Appl. No.: 13/840,080

(22) Filed: Mar. 15, 2013

(51) Int. Cl. G06Q 20/32

(52) U.S. Cl. CPC G06Q 20/3224
USPC 705/21

(57) ABSTRACT

Disclosed are systems and methods of utilizing an initial, automatic authentication of a financial instrument user's identity when the user attempts to make a purchase with a financial instrument at a point-of-sale. Many financial instrument users have cell phones which are able to be located, and users often carry their phones with them when making purchases. An initial authentication of the identity of a credit card user could be made by comparing the location of the point-of-sale with the location of the card user's registered cell phone.

### TECHNICAL FIELD

This disclosure relates generally to a system and method for providing an automatic authentication of a transaction using a financial instrument such that manual authentication could be limited or avoided. More particularly, but not by way of limitation, this disclosure relates to methods and systems to decrease the misuse of financial instruments via the disclosed automatic authentication embodiments.

### BACKGROUND

Typically, the owner of a financial instrument (such as a credit or debit card), may not realize when the instrument is lost or stolen until they actually try to make a purchase or another transaction using that instrument. Alternatively, the owner may notice abnormal transactions in a monthly statement. While the risks of unauthorized transactions may be mitigated by requiring manual authentication of identity at the time of sale, requiring manual authentication can add an additional step to a majority of transactions which are currently not authenticated at the time of purchase. Further, because of the inconvenience, manual authentication is not necessarily performed in many transactions utilizing financial instruments.

Manual authentication may be performed by requiring the financial instrument user to display personal identification, such as a driver's license, at the time that a purchase is made at a merchant (e.g., point-of-sale). While this form of authentication can be effective when it is actually utilized, it also has limits. First, the authentication is limited to situations in which the transaction is conducted with another person, such as with an employee of a merchant. Therefore, this form of authentication may not be available in situations in which a transaction is made at an unmanned point-of-sale, such as at merchants which have an automatic card reader (for example, at an unmanned gas station or a “self-checkout” lane in a store), or at vending machines which accept financial instruments, such as credit/debit cards. As the term is used in this specification, point-of-sale may also include a point of transaction, such as an automatic teller machine (“ATM”). Second, manual authentication through personal identification requires active participation. While the merchant may have a policy of requiring manual authentication by checking personal identification during financial instrument transactions, an employee of the merchant could fail to request personal identification from the instrument user. In these situations, manual authentication requiring the financial instrument user's personal identification may not be effective.

Another form of manual authentication comprises a requirement to enter a personal identification number (“PIN”) at a terminal with a numerical keypad prior to completing the transaction. This is commonly required with transactions using financial instruments such as debit cards, and it may be utilized at both manned and unmanned points-of-sale. However, this technique is also limited because the require ent to enter a PIN often does not extend to transactions using other instruments, such as credit cards or gift cards. Further, always requiring a PIN to be entered can add a transactional cost to each transaction even though the vast majority of transactions are not fraudulent.

Currently, methods and systems to authenticate the usage of a financial instrument at a point-of-sale are limited to manual authentication techniques such as those listed above. To address these and other issues, disclosed are systems and methods to provide an automatic authentication at the time of financial instrument usage, in an effort to reduce misuse of financial instruments while not substantially increasing manual involvement.

### BRIEF DESCRIPTION OF THE DRAWINGS

FIG. 1 is a block diagram illustrating network architecture 100 according to one or more disclosed embodiments.

FIG. 2 is a block diagram illustrating a computer which could be used to execute the technique for automatically authenticating financial instrument transactions according to one or more disclosed embodiments.

FIG. 3 is an illustration of a mobile device, such as a mobile phone, which could be utilized as part of an automatic authentication of financial instrument transactions according to one or more disclosed embodiments.

FIG. 4 is a flowchart of a method for automatically authenticating a financial instrument transaction as disclosed in one or more embodiments.

FIG. 5A shows a top-down view of a geographical area for a first scenario of an automatic authentication of a financial instrument transaction.

FIG. 5B shows a top-down view of a geographical area for a second scenario of an automatic authentication of a financial instrument transaction.

FIG. 6 is a flowchart of a process demonstrating the usage of two different location technologies on a phone for determining the location of the phone.

### DETAILED DESCRIPTION

As explained above, manual authentication of a user's identity at the time a transaction using a financial instrument is conducted may be an effective way of limiting misuse, but there are limitations and drawbacks to manual authentication as well. Therefore, automatically authenticating a financial instrument transaction may be used as a more reliable, regular, and less intrusive method of authentication.

Users of financial instruments are often mobile phone users as well. With the rise in mobile phone usage across the globe, mobile phones are becoming an item that people regularly take with them. This behavior can be leveraged to utilize a user's mobile phone to automatically authenticate a financial instrument transaction by that user, as disclosed further herein. Financial instruments may include credit cards, debit cards, gift cards, gas cards, store credit cards, or other instruments which link a card or other object to a financial account or financial amount. Automatic authentication of financial instruments could be performed by linking a user's cell phone with the financial instruments they use. In one embodiment, a financial instrument issuing entity, such as a bank, could obtain consent and information from the user to link the user's phone to the instrument or account associated with the instrument. In order to register their card, the user could provide his or her cell phone number, which is oftentimes needed by the card issuing entity for other purposes as well. The bank could then link the phone number to the financial instrument or the account associated with the financial instrument.

When the user then attempts to use the instrument in a transaction at a point-of-sale, the location of the user (via the cell phone) and the location of the point-of-sale could be determined. Information regarding the point-of-sale might be available through a database storing information about different points-of-sale. Once both the point-of-sale location and the user's location have been determined, the distance between the two locations may be calculated. If that distance is within a threshold distance, it may be assumed that the financial instrument is being used at the point-of-sale by the correct user. In this way, an automatic authentication of the transaction using the financial instrument may be performed.

In some circumstances, the distance between the user and the point-of-sale might be outside a threshold distance. This might occur in cases if the user has left his or her phone in a different location or if the card user is not the registered card owner. This might occur through appropriate use (an authorized person, such as a family member, is using the card) or misuse (a person who has misappropriated the card is attempting to use it at a point-of-sale). In other circumstances, the location of the card user may be indeterminable. This might occur when the user's phone is off, or in circumstances where a location-determination technique for the phone fails, which might be caused by certain weather conditions, for example. If any of the above scenarios occurs, a secondary technique for authentication, such as manual authentication, may be used. With reference to the Figures, additional embodiments of an automatic transaction authentication according to this disclosure are provided below.

Referring now to FIG. 1, infrastructure 100 is shown schematically. Infrastructure 100 contains computer networks 102. Computer networks 102 include many different types of computer networks available today, such as the Internet, a corporate network or a Local Area Network (LAN). Each of these networks can contain wired or wireless devices and operate using any number of network protocol (e.g., TCP/IP). Networks 102 are connected to gateways and routers (represented by 108), end user computers 106, and computer servers 104. Also shown in infrastructure 100 is cellular network 103 for use with mobile communication. As is known in the art, mobile cellular networks support mobile devices 110, which may include devices such as mobile phones and tablet computers (not separately shown).

Referring now to FIG. 2, an example processing device 200 for use in providing automatic authentication techniques according to one embodiment is illustrated in block diagram form. Processing device 200 may serve as processor in a mobile device 110, gateway or router 108, client computer 106, or a server computer 104. Example processing device 200 comprises a system unit 210 which may be optionally connected to an input device for system 260 (e.g., keyboard, mouse, touch screen, etc.) and display 270. A program storage device (PSD) 280 (sometimes referred to as a hard disk, flash memory, or computer readable medium) is included with the system unit 210. Also included with system unit 210 is a network interface 240 for communication via a network (for example, cellular or computer) with other computing and corporate infrastructure devices (not shown) or other mobile communication devices. Network interface 240 may be included within system unit 210 or be external to system unit 210. In either case, system unit 210 will be communicatively coupled to network interface 240. Program storage device 280 represents any form of non-volatile storage including, but not limited to, all forms of optical and magnetic memory, including solid-state, storage elements, including removable media, and may be included within system unit 210 or be external to system unit 210. Program storage device 280 may be used for storage of software to control system unit 210, data for use by the processing device 200, or both.

System unit 210 may be programmed to perform methods in accordance with this disclosure. System unit 210 comprises one or more processing units, input-output (I/O) bus 250 and memory 230. Memory access to memory 230 can be accomplished using the communication bus 250. Processing unit 220 may include any programmable controller device including, for example, a mainframe processor, a mobile phone processor, or one or more members of the INTEL® ATOM™, INTEL® CORE™, PENTIUM®, and CELERON® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company). Memory 230 may include one or more memory modules and comprise random access memory (RAM), read only memory (ROM), programmable read only memory (PROM), programmable read-write memory, and solid-state memory.

Processing device 200 may have resident thereon any desired operating system. Embodiments of disclosed automatic authentication techniques may be implemented using any desired programming language, and may be implemented as one or more executable programs, which may link to external libraries of executable routines that may be supplied by the provider of the detection software/firmware, the provider of the operating system, or any other desired provider of suitable library routines. As used herein, the term “a computer system” can refer to a single computer or a plurality of computers working together to perform the function described as being performed on or by a computer system.

In preparation for performing disclosed embodiments on processing device 200, program instructions to configure processing device 200 to perform disclosed embodiments may be provided stored on any type of non-transitory computer-readable media, or may be downloaded from a server 104 onto program storage device 280.

Referring now to FIG. 3, mobile phone 300 (an example of mobile device 110 from FIG. 1) is shown. Mobile phone 300 can be configured with one or more processing devices 200. Mobile phone 300 also has a user interface screen 310, a user input mechanism 320, and an antenna 330. Touch screens may be employed to combine user interface screen 310 with user input mechanism 320. Mobile phone 300 can also have multiple antennas for cellular, Wi-Fi, radio frequency identification (“RFID”), near-field communication (“NFC”), etc. In modern mobile phones, user interface 310 and a communication interface (not shown) that communicates with a cellular network via antenna 330 can be controlled by different processing units or processing devices. Among other things, this enables a user of the mobile phone to interact with applications executing on the mobile phone while still engaged in a communication session via the cellular network.

Mobile phone 300 may also be equipped with hardware and software such that location algorithms are able to be executed to locate the phone. These location algorithms may be performed on the phone itself, or by an external server, or through a combination of the two. In this manner, the location of the mobile phone may be determined. Some examples of current location-determination technologies include Uplink-Time Difference of Arrival (U-TDOA), Assisted Global Positioning System (A-GPS), Global Positioning System (GPS), and Cell Global Identity with Timing Advance (CGI-TA). These technologies may locate a device using techniques such as triangulation, multilateration, measuring signal strength, cell identification, satellite positioning, etc. Hybrid techniques that involve combinations of the techniques listed above or other techniques may also be used. Mobile phone 300 may be equipped to be located by one or more of these location determination algorithms and others. It will be understood that location determination technologies employed by mobile phone 300 may be active even when the mobile phone is not being actively interacted with by a user. A mobile phone 300 equipped to be located using one of the location determination algorithms described above or others known in the art can provide a suitable environment to utilize one or ore embodiments of the automatic authentication techniques disclosed herein.

FIG. 4 shows a method 400 by which a financial instrument transaction may be automatically authenticated. Initially, at 410, a financial instrument transaction is initiated at a point-of-sale. The transaction may be initiated, for example, by the swiping of a credit or debit card through a card reader at a merchant site. At 420, the financial instrument transaction is recognized. This might be done by a back-end server system, possibly one operated by the financial instrument issuing company, the financial instrument transaction network, or the acquiring company. The recognition of the financial instrument transaction at 420 could then trigger the automatic authentication of the transaction.

At 430, the mobile device associated with the financial instrument may be determined. A user that has registered their mobile phone with their financial instrument at an entity such as the card issuer can avow that user's mobile phone information to be accessed by the instrument issuer when the transaction is initiated and recognized. The user's mobile phone information may be looked up, for example, through a database at the instrument issuer. Having determined information regarding the user's mobile phone, the determination of the location of the user's phone may be started.

At 440, the location of the point-of-sale can be determined. As many points-of-sale are fixed in a geographical location (such as at a physical storefront), their locations may be stored in a database. As such, if a point-of-sale is a fixed location point-of-sale, then its location may be determined by a database lookup. At 445, a successful location determination allows the method to continue, while an unsuccessful location determination is discussed further below.

At 450, the location of the financial instrument user is determined (via the mobile phone). As mentioned above, if a financial instrument user takes his or her phone with them, the location of the phone will approximate the location of the user. The location of the phone may be determined by any supported location-determination technologies. At 455, a successful location determination allows the method to continue, while an unsuccessful location determination is discussed further below. It should be noted that the location determination for both the point-of-sale and the mobile device may be processed concurrently, or in any order. Once the locations of both the phone and the point-of-sale location are determined, the distance between the two points may be calculated, as shown at 460.

The calculated distance may be compared to a threshold distance, as shown at 470. This threshold distance may be user-selectable, or it may be determined by an entity, such as the card-issuing entity. The threshold could serve to create an upper limit of distance that could indicate when the distance between the user (more specifically, the user's phone) and the point-of-sale location is outside of a tolerable limit. This determination is made at 475. In the instance where the calculated distance is within the threshold, it may be assumed that the financial instrument user is at the point-of-sale, and that the transaction is accordingly authenticated. Accordingly, the transaction may be allowed to complete, as shown at 480. In the situation in which the calculated distance is outside the threshold, it may be assumed that the card user's phone is not at the same location as the point-of-sale, and the automatic authentication could be unsuccessful, as shown at 490. In the event that the automatic authentication is unsuccessful, subsequent actions may be determined based on a policy. This policy-based authentication, or secondary authentication, may be a manual authentication to check identity, such as requiring a PIN to be entered at a terminal or requiring photo identification to be shown to an employee. This policy-based authentication may be prompted at a display at the point-of-sale of the transaction, requiring that an identity check be performed.

As mentioned above, in some instances, the location determination of the phone may be unsuccessful. In these instances, a policy-based authentication may also be triggered, shown as the unsuccessful decision branches from 445 and 455.

FIGS. 5A and 5B demonstrate two different scenarios related to automatically authenticating a financial instrument transaction. FIG. 5A shows a top-down view of a geographical area with point-of-sale 500 shown. Financial instrument user 510 may approach the point-of-sale 500 in order to complete a purchase using a financial instrument. As described above with respect to FIG. 4, the financial instrument user 510 initiates a transaction using the financial instrument at the point-of-sale 500. When this occurs, the transaction initiation (such as a credit card swipe) is detected at a back-end server system. At this time, the location of the point-of-sale and the location of the phone may be determined. In this instance, the distance between the two locations is within the threshold 520, and the transaction may continue.

In FIG. 5B, point-of-sale 501 and financial instrument user 511 are shown. However, in this scenario, the distance between user 511 (i.e., the user's phone) and point-of-sale location 501 exceeds the threshold 521. In this instance, a policy-based determination may be made as to the next steps required to authenticate the transaction that is being attempted at the point-of-sale 501.

In some instances, a location technology on the mobile phone may not be successful in determining a location of the phone. This might be due to external conditions (such as weather), network conditions, or conditions with regard to the phone (such as a low battery condition or a malfunction). In some of these instances, a secondary method of location determination might still be possible. FIG. 6 demonstrates a method 600 for determining a phone's location utilizing two location technologies, as an expansion of step 450 of FIG. 4.

It will be understood that mobile phone location technologies may provide approximate, and not precise, locations. For example a GPS-calculated position for a phone may be accurate to within a distance, such as 50 feet. Another technology may have higher or lower degree of accuracy. If a phone supports multiple location determination technologies, then the most accurate location determination technology may be preferred for an automatic authentication. In this way, if a phone supports two or more location determination technologies, they may be prioritized with respect to usage in the automatic authentication by their respective accuracy.

At 610, a first phone location technology is utilized to try to determine a position of the phone. At decision point 615, two branches may be taken based on whether the location determination is successful. If it is successful, the location of the phone has been determined at 630, and the method 400 from FIG. 4 may be continued. If, however, the location determination is unsuccessful, then a second location determination technology supported by the phone is utilized at 620. Two branches may be taken based on whether the second location determination is successful, as shown at 625. If the second location determination is unsuccessful, then the location of the phone has not been determined, and the method may end with an unsuccessful result, as shown at 640. A successful location determination using the second location method, and the method ends with a successful result at 630.

Of course, if a particular phone supports more than two location determination technologies, then method 600 may be expanded by cycling through each of the available location determination technologies until the location has been determined or until the list of technologies has been exhausted without a successful determination.

Some variations of the above-described methods and techniques will be described below.

As mentioned above, one method in which a transaction may be initiated is by the swiping of a credit card through a card reader at a merchant site. Other ways in which a transaction may be initiated may be by engaging an RFID tag embedded in the card. This may be done, for example, by passing an RFID-enabled card over an RFID-enabled card reader. In both of these scenarios, the location of the card user may be determined by the location of their phone, as long as the card user is with the phone.

Yet another way a transaction may be completed is by an online or telephone transaction, in which the card number and other card-identifying numbers are used. While it may not be possible to authenticate all online and telephonic transactions through a location determination and comparison, some transactions may be automatically authenticated in this way as well. Telephone transactions may be authenticated by determining the location of the telephone from which the transaction is made and comparing that with the location of the mobile device that is registered with the owner of the financial instrument. Transactions may be similarly authenticated for online purchases. With online transactions, the accuracy of the location determination may be a factor to consider. While IP addresses may be located, the accuracy of the location may be questioned. For example, the location determination for a device used to engage in an online transaction may be limited to a large geographic area, such as a city or a section of a city. The determination of whether this level, or degree, of accuracy could be used to authenticate a transaction (or to supplement the authentication of a transaction) may be a policy decision made by the card issuing entity or the owner of the card. Some online and phone transactions, such as when the owner's mobile device itself is the device used to engage in the transaction, may not be appropriate for automatic authentication through location determination.

In some circumstances, the point-of-sale may not be in a fixed location, and the location cannot be determined by a database lookup. With advances in mobile technologies, it is possible for financial instrument readers to be mobile themselves. For example, a merchant may have a mobile phone or a tablet computer with an attachment which allows the phone or tablet to become a point-of-sale and accept financial instruments. For these circumstances, the location of the instrument reader (i.e., the point-of-sale) must also be determined. If the merchant is registered to allow his or her mobile card reader to be located, then the location of the mobile card reader may be determined in the same manner as described above with respect to the financial instrument user. The method 600 described in FIG. 6 may be used to determine the location of the point-of-sale as well.

Further still, in some circumstances, an absolute location determination may not be necessary if a relative location determination is available. As an example, many mobile phones are equipped with short-range communication technologies such as NFC or Bluetooth, NFC and Bluetooth are not used to determine absolute locations, as is possible with technologies like GPS or A-GPS, but may be used to determine a relative distance from one NFC or Bluetooth-equipped device to another. Thus, if the mobile device and the point-of-sale are equipped with NFC, for example, the mobile phone may be automatically authenticated with the point-of-sale using NFC. Therefore, the phone and the registered card both being in the proximity of the point-of-sale location can serve as authentication without requiring actual geographical location of either or both of the point-of-sale and the phone. Note, because these types of “short-range” technologies only operate over small distances, it may therefore be assumed that a successful communication using one of these short-range technologies implies that the point-of-sale and the card user are within a threshold distance of each other. Bluetooth may require pairing between the device and the point-of-sale endpoint. In some cases, a user may pair their mobile device with a point-of-sale location, such as a particular ATM that the user frequents, to enable automatic authentication. In addition, broadcast Bluetooth transmissions made by the owner's mobile device may also be used to authenticate the transaction.

The following examples pertain to further embodiments of this disclosure.

1. A non-transitory computer readable medium comprising computer executable instructions stored thereon to cause one or more processing units to recognize an initiation of a transaction using a financial instrument at a point-of-sale; determine a first location of the point-of-sale; determine a second location of a mobile device associated with the financial instrument; calculate a distance between the first and second location; compare the calculated distance to a threshold distance; and authenticate the transaction based upon a determination that the calculated distance is less than the threshold distance.

2. The non-transitory computer readable medium of example 1, wherein the instructions to cause one or more processing units to recognize an initiation of a financial instrument transaction comprise instructions to cause the one or more processing units to receive transaction information regarding the point-of-sale and the financial instrument; and obtain information pertaining to a mobile device that is associated with the financial instrument.

3. The non-transitory computer readable medium of example 1, further comprising instructions to cause the one or more processing units to identify location detection protocols available on the mobile device.

4. The non-transitory computer readable medium of example 1, wherein the instructions to cause one or more processing units to determine the first location of the point-of-sale comprise instructions to cause the one or more processing units to obtain an address of the point-of-sale from a database.

5. The non-transitory computer readable medium of example 4, wherein the point-of-sale is at a fixed geographic location.

6. The non-transitory computer readable medium of example 1, further comprising instructions to cause the one or more processing units to:

request a policy-based authentication of the transaction based upon a determination that the calculated distance is greater than the threshold distance.

7. The non-transitory computer readable medium of example 6, wherein the policy-based authentication of the transaction comprises a manual authentication of the transaction.

8. The non-transitory computer readable medium of example 7, further comprising instructions to cause one or more processors to prompt a display device at the point-of-sale to instruct a person to perform an identity check.

9. The non-transitory computer readable medium of example 1, further comprising instructions to cause the one or more processing units to request a policy-based authentication of the transaction based upon a failure to determine a location of the mobile device.

10. The non-transitory computer readable medium of example 1, further comprising instructions to cause the one or more processing units to request a policy-based authentication of the transaction based upon a failure to determine a location of the mobile device to a degree of accuracy.

11. The non-transitory computer readable medium of example 1, wherein instructions to cause one or more processing units to determine a location of a mobile device associated with the financial instrument comprise instructions to cause the one or more processing units to attempt to locate the mobile device using a first location detection protocol; detect a failure of the attempt to locate the mobile device using the first location detection protocol; and attempt to locate the mobile device using a second location detection protocol.

12. The non-transitory computer readable medium of example 11, wherein the first location detection protocol permits more accurate location detection than the second location detection protocol.

13. A non-transitory computer readable medium comprising computer executable instructions stored thereon to cause one or more processing units to recognize an initiation of a transaction using a financial instrument at a point-of-sale; identify that a mobile device associated with the financial instrument is within a proximity of the point-of-sale; and authenticate the financial instrument transaction based on a determination that the mobile device is within a proximity of the point-of-sale.

14. The non-transitory computer readable medium of example 13, wherein near-field communication (NFC) is used to identify that a mobile device associated with the financial instrument is within a proximity of the point-of-sale.

15. The non-transitory computer readable medium of example 13, wherein Bluetooth is used to identify that a mobile device associated with the financial instrument is within a proximity of the point-of-sale.

The specifics in the examples above may be used anywhere in one or more embodiments. For instance, all optional features of the apparatus as described above may also be implemented with respect to the methods or processes described herein.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A non-transitory computer readable medium comprising computer executable instructions stored thereon to cause one or more processing units to:
recognize an initiation of a transaction using a financial instrument at a point-of-sale;
determine a first location of the point-of-sale;
determine a second location of a mobile device associated with the financial instrument;
calculate a distance between the first and second location;
compare the calculated distance to a threshold distance; and
authenticate the transaction based upon a determination that the calculated distance is less than the threshold distance.

2. The non-transitory computer readable medium of claim 1, wherein the instructions to cause one or more processing units to recognize an initiation of a financial instrument transaction comprise instructions to cause the one or more processing units to:
receive transaction information regarding the point-of-sale and the financial instrument; and
obtain information pertaining to a mobile device that is associated with the financial instrument.

3. The non-transitory computer readable medium of claim 1, further comprising instructions to cause the one or more processing units to identify location detection protocols available on the mobile device.

4. The non-transitory computer readable medium of claim 1, wherein the instructions to cause one or more processing units to determine the first location of the point-of-sale comprise instructions to cause the one or more processing units to obtain an address of the point-of-sale from a database.

5. The non-transitory computer readable medium of claim 4, wherein the point-of-sale is at a fixed geographic location.

6. The non-transitory computer readable medium of claim 1, further comprising instructions to cause the one or more processing units to:
request a policy-based authentication of the transaction based upon a determination that the calculated distance is greater than the threshold distance.

7. The non-transitory computer readable medium of claim 6, wherein the policy-based authentication of the transaction comprises a manual authentication of the transaction.

8. The non-transitory computer readable medium of claim 7, further comprising instructions to cause one or more processors to prompt a display device at the point-of-sale to instruct a person to perform an identity check.

9. The non-transitory computer readable medium of claim 1, further comprising instructions to cause the one or more processing units to:
request a policy-based authentication of the transaction based upon a failure to determine a location of the mobile device.

10. The non-transitory computer readable medium of claim 1, further comprising instructions to cause the one or more processing units to:
request a policy-based authentication of the transaction based upon a failure to determine a location of the mobile device to a degree of accuracy.

11. The non-transitory computer readable medium of claim 1, wherein instructions to cause one or more processing units to determine a location of a mobile device associated with the financial instrument comprise instructions to cause the one or more processing units to:
attempt to locate the mobile device using a first location detection protocol;
detect a failure of the attempt to locate the mobile device using the first location detection protocol; and
attempt to locate the mobile device using a second location detection protocol.

12. The non-transitory computer readable medium of claim 11, wherein the first location detection protocol permits more accurate location detection than the second location detection protocol.

13. A method of automatically authenticating a financial instrument transaction, comprising:
recognizing, using a processor, an initiation of a transaction using a financial instrument at a point-of-sale;
determining a first location of the point-of-sale;
determining a second location of a mobile device associated with the financial instrument;
calculating a distance between the first and second locations;
comparing the calculated distance to a threshold distance; and
authenticating the financial instrument transaction based upon a determination that the calculated distance is less than the threshold distance.

14. The method of claim 13, further comprising:
receiving transaction information regarding the point-of-sale and the financial instrument; and
obtaining information pertaining to a mobile device that is associated with the financial instrument.

15. The method of claim 13, further comprising:
attempting to locate the mobile device using a first location detection protocol;
detecting a failure of the attempt to locate the mobile device using the first location detection protocol; and
attempting to locate the mobile device using a second location detection protocol.

16. The method of claim 13, wherein the first location detection protocol permits more accurate location detection than the second location detection protocol.

17. A system configured to automatically authenticate a financial instrument transaction, comprising:
a memory;
one or more processing units, communicatively coupled to the memory, wherein the memory stores instructions to configure the one or more processors to:
recognize an initiation of a transaction using a financial instrument at a point-of-sale;
determine a first location of the point-of-sale;
determine a second location of a mobile device associated with the financial instrument;
calculate a distance between the first and second locations;
compare the calculated distance to a threshold distance; and
authenticate the transaction based upon a determination that the calculated distance is less than the threshold distance.

18. The system of claim 17, wherein the memory further stores instructions to configure the one or more processors to:
receive transaction information regarding the point-of-sale and the financial instrument; and
obtain information pertaining to a mobile device that is associated with the financial instrument.

19. The system of claim 17, wherein the memory further stores instructions to configure the one or more processors to:
identify location detection protocols available on the mobile device.

20. The system of claim 17, wherein the memory further stores instructions to configure the one or more processors to:
request a policy-based authentication of the transaction based upon a determination that the calculated distance is greater than the threshold distance.

21. The system of claim 17, wherein the memory further stores instructions to configure the one or more processors to:
request a policy-based authentication of the transaction based upon a failure to determine a location of the mobile device.

22. The system of claim 17, wherein the memory further stores instructions to configure the one or more processors to:
request a policy-based authentication of the transaction based upon a failure to determine a location of the mobile device to a degree of accuracy.

23. A non-transitory computer readable medium comprising computer executable instructions stored thereon to cause one or more processing units to:
recognize an initiation of a transaction using a financial instrument at a point-of-sale;
identify that a mobile device associated with the financial instrument is within a proximity of the point-of-sale; and
authenticate the financial instrument transaction based on a determination that the mobile device is within a proximity of the point-of-sale.

24. The non-transitory computer readable medium of claim 23, wherein near-field communication (NFC) is used to identify that a mobile device associated with the financial instrument is within a proximity of the point-of-sale.

25. The non-transitory computer readable medium of claim 23, wherein Bluetooth is used to identify that a mobile device associated with the financial instrument is within a proximity of the point-of-sale.
